(19) United States
(12) Patent Application Publication
(10) Pub. No.: US 2004/0008218 A1
(43) Pub. Date: Jan. 15, 2004

(54) Screen display configuration method for mobile communication terminals

(75) Inventor: Chang Heui Hong, Gyunggi-Do (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronics Inc.

(21) Appl. No.: 10/603,451

(22) Filed: Jun. 25, 2003

(30) Foreign Application Priority Data
Jul. 9, 2002 (KR) 10-2002-39791

(51) Int. Cl. G09G 5/00

(52) U.S. Cl. 345/700

(57) ABSTRACT

In another embodiment, a display apparatus of a mobile communication terminal connected to a keypad having at least one direction key associated with a direction of rotation of a first image displayed on the display apparatus, such that in response to user manipulation of the direction key a second image is displayed, wherein the second image is a rotated version of the first image in a first direction.

### CROSS REFERENCE TO RELATED APPLICATION

Pursuant to 35 U.S.C. § 119(a), this application claims the benefit of earlier filing date and right of priority to Korean Patent Application No. 2002-39791, filed on Jul. 9, 2002, the content of which is hereby incorporated by reference herein in its entirety.

### BACKGROUND OF THE INVENTION

1. Field of the Invention

The present invention relates to a method of displaying an image on the screen display of a mobile communication terminal, and particularly, to a method for configuring and rotating the image in different orientations.

2. Description of the Background Art

The newer mobile communication terminals provide special functions such as short message service (SMS), memory for telephone numbers, schedules, memos and other information, and also multimedia services, such as chatting, web surfing, and video on demand (VOD).

FIG. 1 is a block diagram showing a configuration of screen display device of a general mobile terminal. The display device comprises a receiving unit 101 for receiving signal inputted through an antenna; a demodulating unit 102 for demodulating the received signal; a display unit 103 for displaying information; a memory 104 for storing data which will be displayed on the display unit 103; a keypad 105 for inputting a predetermined control command; a CPU 106a for configuring image data for display on the display unit 103; and a mobile station modem (MSM) 106, including a display controlling unit 106b for controlling the display unit 103.

When image data for display on the display unit 103 of the mobile terminal is generated, the CPU 106a stores the data in the memory 104 and configures the data for display on the display unit 103. The display data is generated by inputting a predetermined command through the keypad 105 by a user or by receiving the signal through the antenna.

The configured image data is displayed on the display unit 103 through the display controlling unit 106b. Various information can be displayed on the display unit 103 in the above manner. The information is displayed on the display unit in a predetermined orientation. Unfortunately, a user has no control over the display orientation. Depending on the nature of material displayed (e.g., image, text, etc.) and the relative directions of the display material, it would be useful, if the user could control the display orientation.

### SUMMARY OF THE INVENTION

A method of configuring an image displayed on a display unit of a mobile terminal is provided. The method comprises rotating a first image displayed on the display unit, in a first direction, in response to user input to display a second image; and adjusting dimensional configuration of the second image in accordance with dimensions of the display unit.

The user input is provided via a keypad of the mobile terminal. The keypad comprises at least one direction key associated with a direction of rotation for the first image. The keypad comprises first and second direction keys, wherein the first direction key is associated with a clockwise direction of rotation and the second direction key is associated with a counter-clockwise direction of rotation.

Pressing the first direction key causes the first image to be rotated clockwise by approximately 90 degrees. Pressing the second direction key causes the first image to be rotated counter-clockwise by approximately 90 degrees. The keypad further comprises a third direction key, wherein pressing the third direction key causes the first image to be rotated by approximately 180 degrees. The keypad further comprises a fourth direction key, wherein pressing the fourth direction key causes an image displayed on the display unit to be displayed in its original orientation.

In one embodiment, a soft direction key is displayed on the display unit to indicate direction in which the first image is rotated. The display unit has a width A and a height B, and the first image has a height C and a width D, wherein the adjusting step comprises corresponding the height C of the first image with the width A of the display unit, and corresponding the width D of the first image to the height B of the display unit, so that the second image has a width A and a height B.

In one embodiment C is equal to A and D is equal to

$$\frac{{A}^{2}}{B} .$$

If C=A and D=B dimensions of the second image are reduced proportionally, so that the second image fits within boundaries of the display unit. The soft direction key is displayed when the second image is a rotated representation of the first image. The soft direction key comprises a left soft direction key for representing that the first image is rotated counter-clockwise. In certain embodiments, the soft direction key comprises a right soft direction key for representing that the first image is rotated clockwise. The right and left soft direction key flickers. The second image has the same width-height aspect ratio as the first image.

In another embodiment, a display apparatus of a mobile communication terminal connected to a keypad having at least one direction key associated with a direction of rotation of a first image displayed on the display apparatus, such that in response to user manipulation of the direction key a second image is displayed, wherein the second image is a rotated version of the first image in a first direction.

Dimensional configurations of the second image are adjusted in accordance with dimension of the display apparatus. The keypad comprises first and second direction keys, wherein the first direction key is associated with a clockwise direction of rotation and the second direction key is associated with a counter-clockwise direction of rotation.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a screen display device for a general mobile terminal;

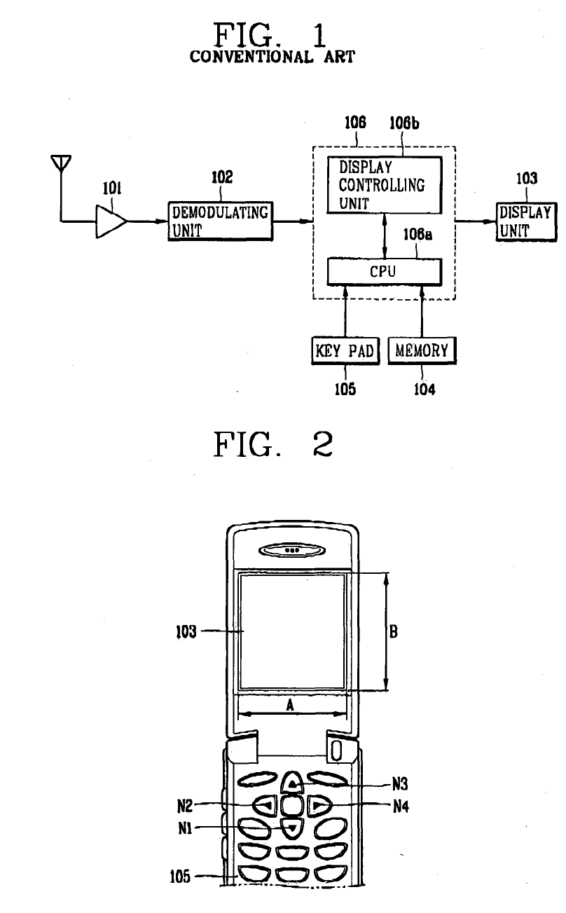

FIG. 2 is a frontal planner view of a mobile terminal, according to one embodiment of the present invention;

FIGS. 3A, 3B, 3C and 3D are exemplary views of an image rotated in various directions, in accordance with one embodiment of the invention; and

FIG. 4 is a flow chart illustrating a screen display configuration method, according to one embodiment of the present invention.

Features, elements, and aspects of the invention that are referenced by the same numerals in different figures represent the same, equivalent, or similar features, elements, or aspects in accordance with one or more embodiments of the system.

### DETAILED DESCRIPTION OF THE PREFERRED EMBODIMENTS

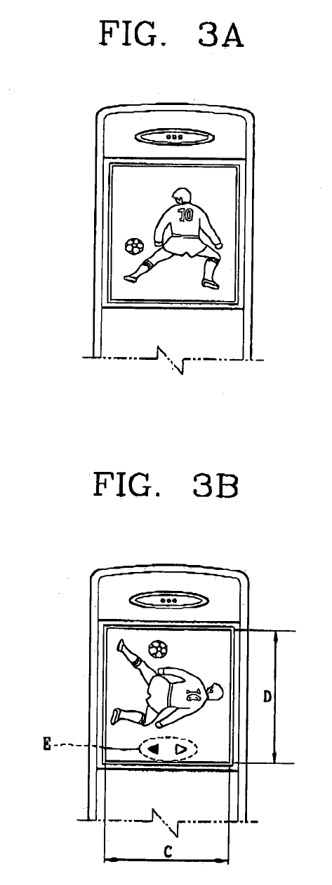

Referring to FIG. 2, the display unit 103 is set to have a longer length (B) than a width (A), in accordance with one embodiment. Therefore, the display unit 103 of the mobile terminal displays an image in an orientation with a longer length than its width.

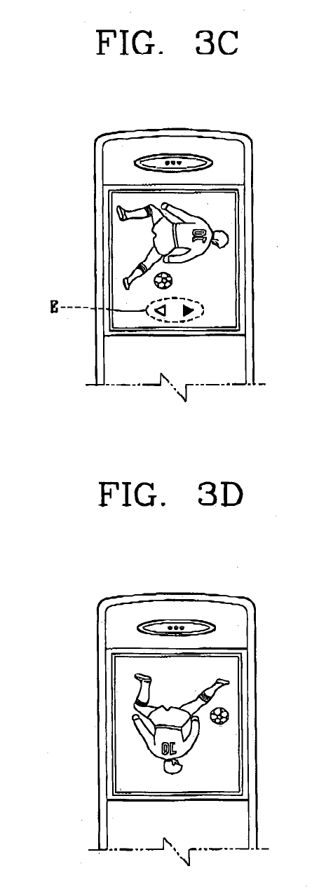

In one embodiment, directional keys (e.g., N1, N2, N3 and N4) on the keypad 105 are provided for rotating an image on the display unit 103. In some embodiments, additional or other keypad buttons can be set to rotate the image. FIGS. 3A, 3B, 3C and 3D are exemplary views showing rotated images. FIG. 3A, for example, shows a normally displayed image. FIGS. 3B and 3C, for example, show images rotated approximately 900 in respectively, clockwise or counter-clockwise directions. FIG. 3D shows the image rotated approximately 180°.

In one embodiment, when the user presses the left direction button N2 once, for example, the image shown in the display unit 103 is rotated counter-clockwise by approximately 90°. When the right direction button N4 is pressed once or the left direction button N2 is pressed three times, the image of the display unit 103 is rotated clockwise by approximately 90°. To flip the image upside down, as shown in FIG. 3D, the upper direction button N3, for example, can be pressed.

The upside down image shown in FIG. 3D can be displayed by changing the direction of the original image, and therefore, the image has the same aspect ratio as that of the original image shown in FIG. 3A. However, in case that the image of the display unit 103 is rotated by approximately 90°, as shown in FIGS. 3B and 3C, the aspect ratio of the display unit 103 is changed from A:B to C:D in order to prevent the image from being distorted. As such, in one embodiment, the width C of the rotated image will correspond to A, and the length D will correspond to

$$\frac{{A}^{2}}{B} ,$$

for example. An empty space may be generated on lower end of the image on the display unit 103, as a result of adjustments made to the image's dimensions.

In one or more embodiments, the length of the display unit 103 is longer than the width of the display unit 103, and therefore, the size of the image is reduced since the aspect ratio is applied based on the width of the display unit 103 in order to rotate the image without distorting the image on the display unit 103.

Referring to FIGS. 3B and 3C, in one embodiment, a soft direction key (E) for presenting the rotational direction of the image with respect to the normal image is shown on the display unit 103. Accordingly, a user can determine the rotation direction of the image based on the soft direction key E. The soft direction key E comprises a left soft direction key for indicating the rotation of image in counter-clockwise direction, and a right soft direction key for indicating the rotation of image in clockwise direction. The soft direction key E that corresponds to the direction of rotation is repeatedly flickered to indicate the direction of rotation, in one or more embodiments.

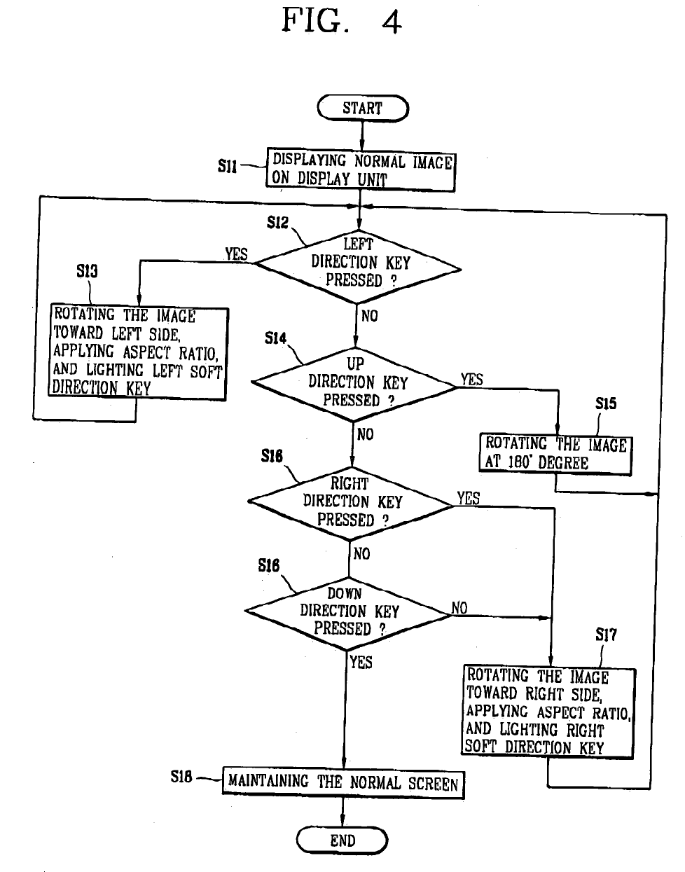

Referring to FIG. 4, in certain embodiments, an image is displayed on the display unit 103, such that the ratio between the width and length of the normal image is A:B (S11). When the user presses the left direction button N2 (S12), the image on the display unit 103 is rotated clockwise by approximately 90°. Then, the size of the image is converted to the ratio of C:D based on the aspect ratio A:B. The right soft direction key in the soft direction key E is then formed on the display (S13). In some embodiments, the soft direction key E blinks to indicate the change in image orientation.

If the user presses the up direction button N3 (S14), the image of the display unit 103 is rotated by approximately 180° with the same aspect ratio as those of the normal image (S15). When the user presses the right direction button N4 (S16), the image of the display unit 103 is rotated counter-clockwise by approximately 90°. The size of the image is converted as C:D ratio and the left soft direction key E is formed on the display (S17).

If the down direction key N1 is pressed the image is displayed in its original orientation. It should be noted that depressing the direction keys N2 and N4 multiple times, results in rotation of the image several times in the corresponding direction (S18).

According to the display configuration method for the mobile terminal as described above, the image displayed on the display unit of the mobile terminal can be configured rotated, and therefore, the image can be viewed from various orientations. Also, the user is able to recognize the rotation of the image on the display unit through the soft direction key. Image distortion problem due to the difference in width and length of the display unit is solved by applying the aspect ratio of the original image to the rotated image, and/or by reducing the size of the rotated image as provided above.

Embodiments of the invention are described by way of example as applicable to systems and corresponding methods in a mobile communication terminal. In this exemplary embodiment, logic code for performing these methods is implemented in the form of, for example, application software. The logic code, in one embodiment, may be comprised of one or more modules that execute on one or more processors in a distributed or non-distributed communication model.

It should also be understood that the programs, modules, processes, methods, and the like, described herein are but an exemplary implementation and are not related, or limited, to any particular computer, apparatus, or computer programming language. Rather, various types of general-purpose computing machines or devices may be used with logic code implemented in accordance with the teachings provided, herein. Further, the order in which the steps of the present method is performed is purely illustrative in nature. In fact, the steps can be performed in any order or in parallel, unless indicated otherwise by the present disclosure.

The method of the present invention may be performed in either hardware, software, or any combination thereof, as those terms are currently known in the art. In particular, the present method may be carried out by software, firmware, or macrocode operating on a computer or computers of any type. Additionally, software embodying the present invention may comprise computer instructions in any form (e.g., ROM, RAM, magnetic media, punched tape or card, compact disk (CD) in any form, DVD, etc.). Furthermore, such software may also be in the form of a computer signal embodied in a carrier wave, or transferred among computers connected to the Internet. Accordingly, the present invention is not limited to any particular platform, unless specifically stated otherwise in the present disclosure.

Thus, methods and systems for providing rotating a displayed image are provided. The embodiments described above are to be considered in all aspects as illustrative only and not restrictive in any manner. Thus, other exemplary embodiments, system architectures, platforms, and implementations that can support various aspects of the invention may be utilized without departing from the essential characteristics described herein. These and various other adaptations and combinations of features of the embodiments disclosed are within the scope of the invention. The invention is defined by the claims and their full scope of equivalents.

What is claimed is:

1. A method of configuring an image displayed on a display unit of a mobile terminal comprising:
rotating a first image displayed on the display unit, in a first direction, in response to user input to display a second image; and
adjusting dimensional configuration of the second image in accordance with dimensions of the display unit.

2. The method of claim 1, wherein the user input is provided via a keypad of the mobile terminal.

3. The method of claim 2, wherein the keypad comprises at least one direction key associated with a direction of rotation for the first image.

4. The method of claim 3, wherein the keypad comprises first and second direction keys, wherein the first direction key is associated with a clockwise direction of rotation and the second direction key is associated with a counter-clockwise direction of rotation.

5. The method of claim 4, wherein pressing the first direction key causes the first image to be rotated clockwise by approximately 90 degrees.

6. The method of claim 4, wherein pressing the second direction key causes the first image to be rotated counter-clockwise by approximately 90 degrees.

7. The method of claim 4, wherein the keypad further comprises a third direction key, wherein pressing the third direction key causes the first image to be rotated by approximately 180 degrees.

8. The method of claim 4, wherein the keypad further comprises a fourth direction key, wherein pressing the fourth direction key causes an image displayed on the display unit to be displayed in its original orientation.

9. The method of claim 1, further comprising:
displaying a soft direction key on the display unit to indicate direction in which the first image is rotated.

10. The method of claim 1, where in the display unit has a width A and a height B, and the first image has a height C and a width D, wherein the adjusting step comprises:
corresponding the height C of the first image with the width A of the display unit, and
corresponding the width D of the first image to the height B of the display unit, so that the second image has a width A and a height B.

11. The method of claim 10, wherein C=A.

12. The method of claim 10, wherein
$$D = \frac{{A}^{2}}{B} .$$

13. The method of claim 10, wherein C=A and D=B, the method further comprising reducing dimensions of the second image proportionally, so that the second image fits within boundaries of the display unit.

14. The method of claim 9, wherein the soft direction key is displayed when the second image is a rotated representation of the first image.

15. The method of claim 9, wherein the soft direction key comprises a left soft direction key for representing that the first image is rotated counter-clockwise.

16. The method of claim 9, wherein the soft direction key comprises a right soft direction key for representing that the first image is rotated clockwise.

17. The method of claim 15, wherein the left soft direction key flickers.

18. The method of claim 16, wherein the right soft direction key flickers.

19. The method of claim 1, wherein the second image has the same width-height aspect ratio as the first image.

20. A display apparatus of a mobile communication terminal connected to a keypad having at least one direction key associated with a direction of rotation of a first image displayed on the display apparatus, such that in response to user manipulation of the direction key a second image is displayed, wherein the second image is a rotated version of the first image in a first direction.

21. The display apparatus of claim 20, wherein dimensional configurations of the second image are adjusted in accordance with dimension of the display apparatus.

22. The display apparatus of claim 21, wherein the keypad comprises first and second direction keys, wherein the first direction key is associated with a clockwise direction of rotation and the second direction key is associated with a counter-clockwise direction of rotation.

23. The display apparatus of claim 22, wherein pressing the first direction key causes the first image to be rotated clockwise by approximately 90 degrees.

24. The display apparatus of claim 22, wherein pressing the second direction key causes the first image to be rotated counter-clockwise by approximately 90 degrees.

25. The display apparatus of claim 22, wherein the keypad further comprises a third direction key, wherein pressing the third direction key causes the first image to be rotated by approximately 180 degrees.

26. The display apparatus of claim 25, wherein the keypad further comprises a fourth direction key, wherein pressing the fourth direction key causes the first image to be displayed in its original orientation.

27. The display apparatus of claim 20, wherein a soft direction key appears on the display unit to indicate direction of rotation of the first image.

28. The display apparatus of claim 20, where in the display unit has a width A and a height B, and the first image has a height C and a width D, wherein the height C of the first image corresponds with the width A of the display unit, and the width D of the first image corresponds with the height B of the display unit, so that the second image has a width A and a height B.

29. The display apparatus of claim 28, wherein C=A.

30. The display apparatus of claim 28, wherein
$$D = \frac{{A}^{2}}{B} .$$

31. The display apparatus of claim 28, wherein C=A and D=B, such that dimensions of the second image are proportionally reduced, so that the second image fits within boundaries of the display unit.

32. The display apparatus of claim 27, wherein the soft direction key is displayed when the second image is a rotated representation of the first image.

33. The display apparatus of claim 32, wherein the soft direction key comprises a left soft direction key for representing that the first image is rotated counter-clockwise.

34. The display apparatus of claim 32, wherein the soft direction key comprises a right soft direction key for representing that the first image is rotated clockwise.

35. The display apparatus of claim 33, wherein the left soft direction key flickers.

36. The display apparatus of claim 34, wherein the right soft direction key flickers.

37. The display apparatus of claim 20, wherein the second image has the same width-height aspect ratio as the first image.
